(19) United States
(12) Patent Application Publication
(10) Pub. No.: US 2024/0399493 A1
(43) Pub. Date: Dec. 5, 2024

(54) FRICTION PRESSURE WELDING OF SIMILAR AND/OR DISSIMILAR MATERIALS

(71) Applicant: UT-Battelle, LLC, Oak Ridge, TN (US)

(72) Inventors: Yong Chae Lim, Oak Ridge, TN (US); Zhili Feng, Oak Ridge, TN (US)

(21) Appl. No.: 18/732,945

(22) Filed: Jun. 4, 2024

Related U.S. Application Data
(60) Provisional application No. 63/471,003, filed on Jun. 5, 2023.

(51) Int. Cl. B23K 20/12; B23K 37/08

(52) U.S. Cl. CPC B23K 20/1255; B23K 20/1225; B23K 20/1265; B23K 37/08

(57) ABSTRACT

A method for friction pressure welding a top workpiece to a bottom workpiece is provided. The method includes plunging a non-consumable refractory tool into the top workpiece with axial plunge pressure and rotational motion. The friction heat generated by the interaction between the tool and the top workpiece diffuses into the faying joint interface and into the bottom workpiece. Friction heat and applied axial plunge pressure promote diffusion bonding at the faying joint interface, which consolidates as a solid-state weld. This inventive method is suitable for spot welding or continuous linear welding, and each workpiece can be comprised of similar or dissimilar materials. After the workpieces are joined, the refractory tool is retracted from the top workpiece. Control variables can include plunge depth, force, and rate of rotation, which can be readily optimized for different material combinations for sound joint formation.

### CROSS-REFERENCE TO RELATED APPLICATIONS

This application claims the benefit of U.S. Provisional Application 63/471,003, filed Jun. 5, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to friction pressure welding processes for joining materials through the application of heat and pressure.

### BACKGROUND OF THE INVENTION

A number of processes exist for the joining of materials, particularly in automotive and aerospace applications. Among them, friction stir welding is a solid-state joining process used to bond materials, primarily metals, without melting them. In friction stir welding, a cylindrical, non-consumable tool is rotated and plunged into the joint between two workpieces. The rotation of the tool generates frictional heat, softening the material around the tool without reaching its melting point. The softened material is then mechanically stirred by the rotating tool, mixing the materials and forming a solid-state bond as the tool moves along the joint line. However, complex material flow caused by relative rotation of the workpieces is known to cause inhomogeneous microstructures, potentially leading to deteriorating mechanical joint performance. Also, large axial stresses, particularly for high strength materials, result in a shortened tool life due to damage and wear. Lower mechanical bonding strength can be a critical issue due to the limited bonding area induced in friction stir sport welding.

Accordingly, there remains a continued need for an improved solid-state welding process for joining two or more workpieces. In particular, there remains a continued need for an improved solid-state welding process for joining similar or dissimilar materials to overcome the drawbacks of conventional methods such as friction stir welding.

### SUMMARY OF THE INVENTION

An improved method for friction pressure welding is provided. The method includes plunging a non-consumable refractory tool onto a top workpiece with axial plunge pressure and rotational motion. The friction heat generated by the interaction between the tool and the top workpiece diffuses into the faying joint interface (where the upper workpiece and the lower workpiece are in contact with each other) and into the lower workpiece. Friction heat and applied axial plunge pressure will promote diffusion bonding at the faying joint interface, which consolidates as a solid-state weld. After the workpieces are joined, the refractory tool is retracted from the top workpiece. This method is suitable for spot welding or continuous linear welding, and each workpiece can be comprised of similar or dissimilar materials. Because the tool lacks a pin (which is found in friction stir welding), there is no complex material flow at the joint interface. Instead, the present method relies on metallurgical bonding at the faying interface by heat and pressure. Control variables can include plunge depth, plunge speed, force, dwell time, and rate of rotation, which can be readily optimized for different material combinations for sound joint formation.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a schematic representation of a method of friction pressure welding for joining multiple workpieces.

FIG. 2(a) is a cross-sectional image of conventional friction stir spot welding, in contrast to FIG. 2(b) which is a cross-sectional image of friction pressure welding.

FIG. 3 is a cross-sectional image of galvannealed dual phase 1180 steel and high strength aluminum alloy 7085.

FIG. 4 is a schematic representation of a multi-layer stack having an interlayer between the upper and lower workpieces.

FIG. 5 illustrates various refractory tools for a method of friction pressure welding an upper workpiece to a lower workpiece.

FIG. 6 is a schematic representation of a tool holder for a refractory tool for a method of friction pressure welding.

FIG. 7 is a schematic representation of engineered faying surface for a method of friction pressure welding in accordance with one embodiment.

### DETAILED DESCRIPTION OF THE CURRENT EMBODIMENTS

As discussed herein, the current embodiments relate to a method for friction pressure welding. The method generally includes plunging a non-consumable refractory tool onto a top workpiece with axial plunge pressure and rotational motion. The friction heat generated by the interaction between the refractory tool and the top workpiece diffuses into the faying joint interface, creating a metallurgical bond between the top workpiece and the bottom workpiece. After the workpieces are joined, the refractory tool is retracted. Each step is discussed below.

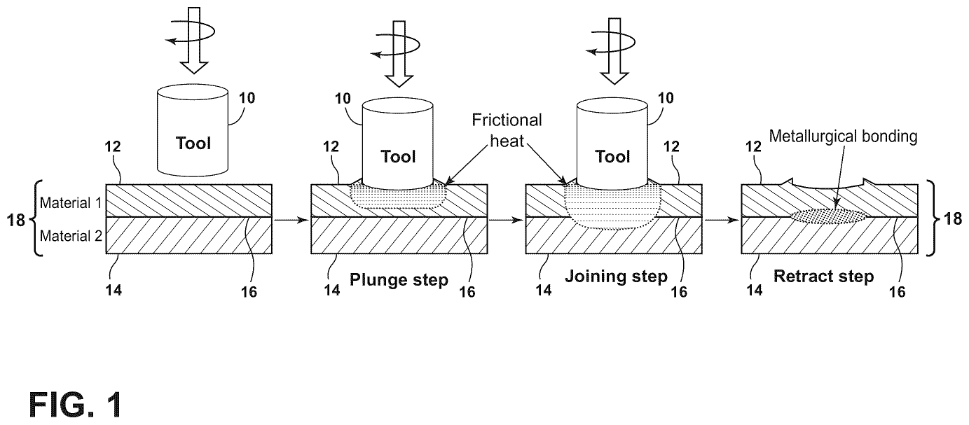

With reference to FIG. 1, plunging the refractory tool 10 includes bringing the refractory tool 10 into contact with the upper workpiece 12, the upper workpiece 12 being positioned atop the lower workpiece 14 such that an interface 16 exists therebetween. The refractory tool 10 experiences a compressive load that is perpendicular to the interface 16 to be welded. While under a compressive load, the refractory tool 10 is simultaneously rotated. Alternatively, the workpiece stack 18 (comprising the upper and lower workpieces 14, 16) may be rotated, such that relative rotation exists as between the refractory tool 10 and the upper workpiece 12. Still further optionally, the workpiece stack 18 and the refractory tool 10 may be rotated in counter-directions, such that such that relative rotation exists as between the refractory tool 10 and the upper workpiece 12. The material of the upper workpiece 12 and the lower workpiece 14 are not particularly limited so long as the effect of the present invention is not impaired.

In particular, the workpieces 12, 14 can comprise similar or dissimilar materials. While not limited to any particular material, the present method can be used to join workpieces comprising aluminum and its alloys, magnesium and its alloys, titanium and its alloys, and steel and its alloys, including stainless steel. In some embodiments, the workpieces 12, 14 include the same thickness (depth), while in other embodiments the workpieces 12, 14 include different thicknesses, with the upper workpiece 12 being thicker or thinner than the lower workpiece 14.

In addition, the shape and the size of the upper workpiece 12 and the lower workpiece 14 are not limited, as long as the effect of the friction pressure welding method is not impaired. The present method can be adapted for a wide range of materials, having a variable plunge depth, plunge speed, plunge force, dwell time, and rotational speed. For example, the plunge depth (the depth at which the refractory tool 10 penetrates the upper workpiece 12) can be between 0.1 mm to 1 mm, inclusive, optionally not exceeding the thickness of the upper workpiece 12, such that the tool does not contact the lower workpiece 14. Also by example, the plunge speed (the speed at which the refractory tool impacts the upper workpiece 12) can be between 0.1 mm/min to 10 mm/min. The plunge force (the maximum force at which the refractory tool is lowered onto the upper workpiece) can be between 500 N to 20 kN. Lastly, the rotational speed (the speed at which the refractory tool 10 rotates when in contact with the upper workpiece 12) can be between 100 rpm to 10,000 rpm. Still other processing parameters are available in other embodiments.

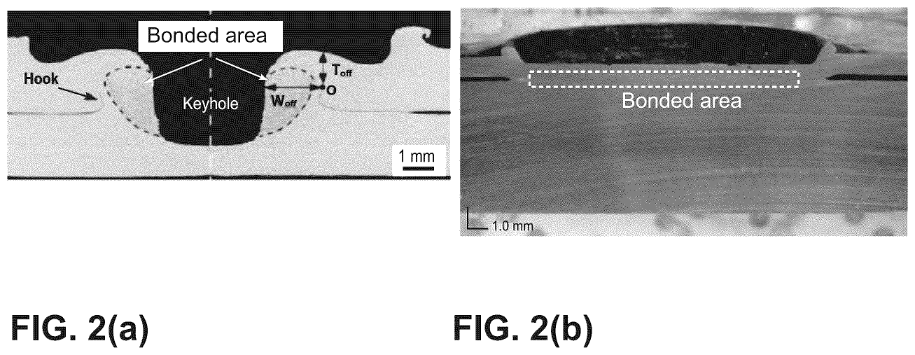

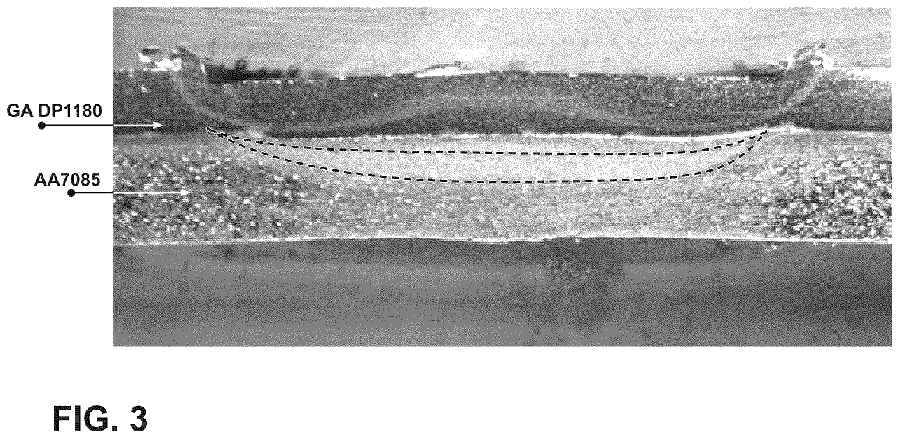

In accordance with the method described above, the formation of large inhomogeneous microstructures can be avoided due to minimal material flow at the bonding interface. In addition, a relatively large bonding area can be achieved, unlike conventional friction stir welding. As shown in FIG. 2(a) for example, friction stir welding provides a lateral bonding area that surrounds a keyhole. In FIG. 2(b), by contrast, the bonding area is relatively large without a hook feature at the joint interface. FIG. 3 further shows an optical image of a cross-sectioned friction pressure weld joint of galvannealed dual phase (DP) 1180 steel (top) and high strength aluminum 7085 (bottom). In this case, a giga pascal steel sheet (i.e., DP1180) was placed on the top for effective heat generation and conduction at the joint interface. In this regard, the excessive heat generation and property degradation of the aluminum alloy can be minimized. From lap shear tensile testing, the average peak failure load was 6.6 kN, which is higher than the lap shear tensile strengths available from relevant technical literature. Because this process can join the giga steel to giga steel under solid-state (i.e., not melting), it can potentially mitigate liquid metal embrittlement when fusion resistance spot welding is used for zinc coated giga steel.

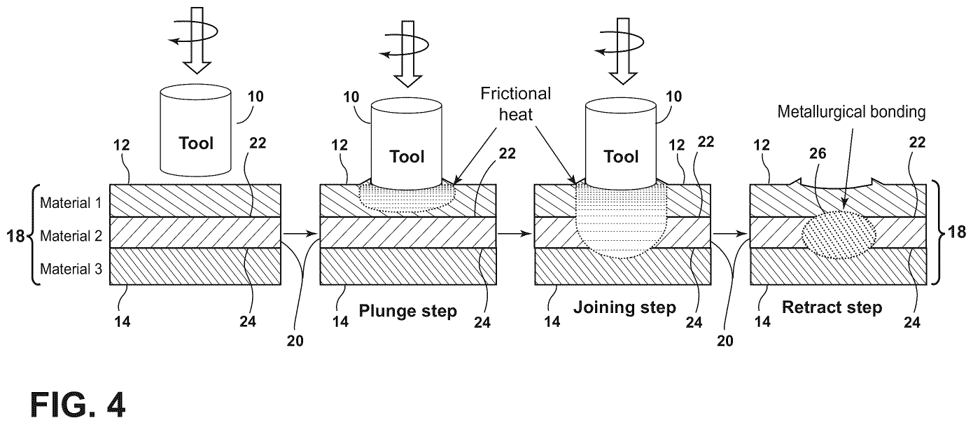

As also shown in FIG. 4, the method of the present invention can be used to join more than two workpieces in a multi-layer stack. For example, the multi-layer stack 18 can include one or more interlayers 20. As used herein, an interlayer 20 is any layer disposed between an upper workpiece 12 and a lower workpiece 14. The interlayer 20 can be similar or dissimilar to the upper workpiece 12 and the lower workpiece 14. The interlayer 20 can be fully crystal, semi-crystal, amorphous, intermetallic, polymeric, and/or an adhesive to promote metallurgical bonding and/or chemical bonding between dissimilar or similar materials. In this example, the friction heat generated by the interaction between the refractory tool 10 and the top workpiece 12 diffuses into an upper faying joint interface 22 and a lower faying joint interface 24, creating a metallurgical bond 26 between the top workpiece and the bottom workpiece, the metallurgical bond extending through the interlayer 20. While only a single interlayer is shown in FIG. 4, other embodiments include two or more interlayers 20 between the upper workpiece 12 and the lower workpiece 14.

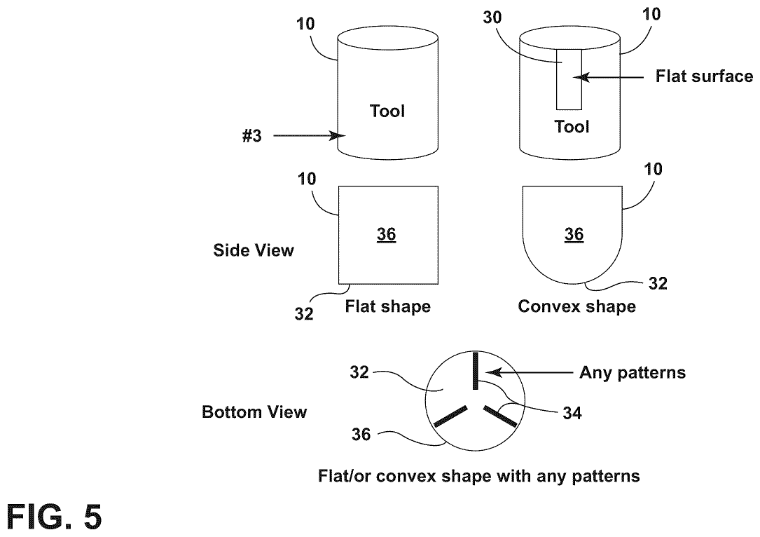

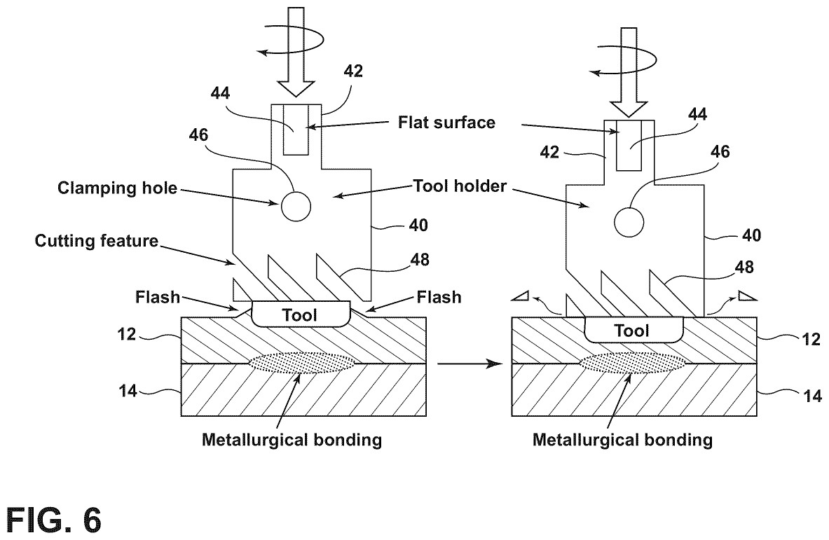

Turning now to FIG. 5, the present method is not limited to any single refractory tool. The refractory tool 10 can be cylindrical, for example, optionally having one or more flat surfaces 30 to prevent self-spinning inside of a tool holder (discussed below in connection with FIG. 6). A set screw, a chuck, or other mechanical fastener can be applied to the flat surface 30 to secure the refractory tool 10 to a corresponding tool holder. The lowermost portion of the refractory tool 10 includes an engagement surface 32 that is flat or contoured, for example convex or hemispherical. The engagement surface 32 can include one or more raised features 32. As also shown in FIG. 5, the engagement surface 32 (whether flat or contoured) can include n-number of raised ribs 34 that are disposed at 360/n degree intervals and that extending radially toward the outer sidewall 36 of the refractory tool 10. For example, the engagement surface 32 can include three raised ribs 34 that are disposed at 120-degree intervals or four raised ribs 34 that are disposed at 90-degree intervals. The tool material can comprise a high-strength, wear resistant material, optionally a ceramic material, to endure high localized temperatures and to prevent bonding between the upper workpiece 12 and the engagement surface 32 of the refractory tool 10.

In order to drive the refractory tool 10 with the desired axial load and relative rotation, the refractory tool 10 is secured to a tool holder. As shown in FIG. 6, the tool holder 40 includes an input shaft 42 with or without one or more flat surfaces 44 for securing the tool holder 10 to a welding machine via set screws or bolts. The one or more flat surfaces 44 can be used to prevent self-spinning during the welding process. One or more clamping holes 46 can be paired with a suitable set screw or bolt to secure the refractory tool 10 within the tool holder 40. An optional cutting feature 48 at the base of the tool holder 40 can be used to remove any flash material that is generated when the refractory tool 10 is plunged into the top workpiece 12. This cutting feature can be beneficial to remove a post-cleaning process as often required for cosmetic purposes. The tool holder 40 can comprise a high-strength, temperature resistant refractory material to endure high localized temperatures as part of the friction welding process.

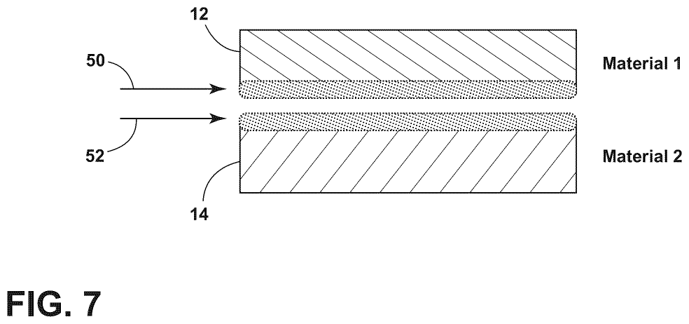

Lastly, the engagement surfaces 50, 52 of the upper and lower workpieces 12, 14 can be modified to promote a strong metallurgical bond. As shown in FIG. 7, the engagement surfaces 50, 52 comprise the faying joint interface of the workpiece stack. By non-limiting example, the engagement surfaces 50, 52 can be treated by mechanical abrasion, laser surface texturing, acid treatments, plasma treatments, silane treatments, and combinations thereof. These surface treatments can also remove an outer oxide layer, can produce functional chemical groups, and/or can create micro-scale or nano-scale mechanical feature for multi-scale interlocking that can enhance the joint strength of the metallurgical bond.

To reiterate, embodiments of the present invention include plunging a non-consumable refractory tool onto a top workpiece with axial plunge pressure and rotational motion. The friction heat generated by the interaction between the tool and the top workpiece diffuses into the faying joint interface and into the bottom workpiece. Friction heat and applied axial plunge pressure promote diffusion bonding at the faying joint interface, which consolidates as a solid-state weld. This method is suitable for spot welding or continuous linear welding, and each workpiece can be comprised of similar or dissimilar materials. After the workpieces are joined, the refractory tool is retracted from the top workpiece. Because the tool lacks a pin (which is found in friction stir welding), there is no complex material flow at the joint interface. Instead, the present method relies on metallurgical bonding at the faying interface by heat and pressure. Control variables can include plunge depth, force, and rate of rotation, which can be readily optimized for different material combinations for sound joint formation.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method comprising:
plunging a refractory tool onto an upper surface of a first workpiece, the first workpiece being in direct or indirect contact with a second workpiece along an interface;
applying an axial load to the refractory tool while simultaneously rotating the refractory tool relative to the first workpiece, wherein heat generated at the upper surface of the first workpiece diffuses into a faying joint interface between the first workpiece and the second workpiece to create a metallurgical bond therebetween without exceeding the melting temperature of the first workpiece or the melting temperature of the second workpiece, such that the metallurgical bond is a solid-state weld joint; and
retracting the refractory tool from the first workpiece, wherein the refractory tool does not penetrate the first workpiece.

2. The method of claim 1, wherein the first workpiece comprises a first material and wherein the second workpiece comprises a second material, the first material being different than the second material.

3. The method of claim 1, wherein the first workpiece comprises a first material and wherein the second workpiece comprises a second material, the first material being identical to the second material.

4. The method of claim 1, wherein rotating the refractory tool relative to the first workpiece includes rotating the refractory tool in a clockwise manner or counterclockwise manner.

5. The method of claim 1, wherein rotating the refractory tool relative to the first workpiece includes rotating the refractory tool in each of a clockwise manner and a counterclockwise manner.

6. The method of claim 1, wherein the refractory tool penetrates the first workpiece with a depth of between 0.1 mm and 1 mm or less than a thickness of the first workpiece.

7. The method of claim 1, wherein first workpiece and the second workpiece comprise a multi-layer stack, the multi-layer stack further including at least one interlayer between the first workpiece and the second workpiece.

8. The method of claim 1, wherein the refractory tool includes a flat engagement surface or a contoured engagement surface.

9. The method of claim 1, wherein an engagement surface of the refractory tool includes a plurality of raised features.

10. The method of claim 1, wherein the refractory tool comprises a flat side surface for securing the refractory tool to a tool holder.

11. The method of claim 10, wherein the tool holder includes a cutting feature comprising serrations for removing flashing from the upper surface of the first workpiece.

12. The method of claim 1, further including pre-treating a lower surface of the first workpiece and an upper surface of the second workpiece to promote the metallurgical bond therebetween.

13. The method of claim 12, wherein pretreating the lower surface and the upper surface includes mechanical abrasion, laser surface texturing, acid treatments, plasma treatments, silane treatments, or combinations thereof.

14. The method of claim 1, wherein the melting temperature of the first workpiece is greater than the melting temperature of the second workpiece.

15. The method of claim 1, wherein rotating the refractory tool includes a rotational speed of between 100 rpm to 10,000 rpm.

16. The method of claim 1, wherein plunging the refractory tool onto the upper surface of the first workpiece includes a plunge speed of between 0.1 mm/min to 10 mm/min.

17. The method of claim 1, wherein the first workpiece includes aluminum, magnesium, titanium, steel, or alloys thereof.

18. The method of claim 17, wherein the second workpiece includes aluminum, magnesium, titanium, steel, or alloys thereof.

19. The method of claim 1, wherein the metallurgical bond comprises an elongated bonding area having a uniform cross-sectional thickness.

20. A friction pressure welding part manufactured according to the method of claim 1.
